(19) United States
(12) Patent Application Publication
(10) Pub. No.: US 2024/0109036 A1
(43) Pub. Date: Apr. 4, 2024

(54) EXHAUST GAS TREATMENT SYSTEM FOR REDUCING AMMONIA EMISSIONS FROM MOBILE GASOLINE APPLICATIONS

(71) Applicant: BASF Corporation, Florham Park, NJ (US)

(72) Inventors: Manale Maalouf, Stuttgart (DE); Florian Waltz, Hannover (DE); Karifala Dumbuya, Hannover (DE); Marcus Hilgendorff, Hannover (DE); Markus Kinne, Hannover (DE); Thomas Schmitz, Hannover (DE)

(21) Appl. No.: 18/274,503

(22) PCT Filed: Feb. 1, 2022
(86) PCT No.: PCT/EP2022/052373

§ 371 Date: Jul. 27, 2023

(30) Foreign Application Priority Data
Feb. 2, 2021 (EP) 21154708.8

(51) Int. Cl. B01D 53/94

(52) U.S. Cl. CPC B01D 53/9477; B01D 53/9418; B01D 53/9436; B01D 53/945; B01D 2255/102; B01D 2255/20761; B01D 2255/50; B01D 2255/908; B01D 2255/9155; B01D 2257/404; B01D 2257/406; B01D 2258/012

(57) ABSTRACT

The present invention relates to an exhaust gas treatment system for reducing ammonia emission from a gasoline engine comprising a three-way conversion catalyst (TWC) or a four-way conversion catalyst (FWC), further comprising an ammonia oxidation catalyst (AMOx) or a selective catalytic reduction catalyst (SCR), and a method of treating exhaust gas from a gasoline engine with an exhaust gas treatment system capable of removing ammonia.

The present invention relates to the field of exhaust gas treatment systems of gasoline engines. The present invention also relates to a method for treating exhaust gas emissions from gasoline engines or removing ammonia.

Emission regulations for exhaust gas from mobile gasoline applications have been increasingly stringent in the past and will presumably lead to even stricter regulations in the future. Accordingly, more effective exhaust gas treatment systems for automotives will be required in the coming years. Efficient ways of removing the main pollutants from gasoline engines including nitrogen oxides (NOx), unburned hydrocarbons (HC), carbon monooxide (CO) and particulate matter have been developed and commercialized in the past based on the so-called three way conversion catalysts (TWC) or four way conversion catalysts (FWC).

However, it is possible that future emission regulations could also impose stricter limits to secondary emissions from exhaust gas. For instance, more stringent European emission standards like EURO 7 or comparable regulations in the US may impose restrictions to ammonia (NH₃) tailpipe emissions.

Studies have shown that ammonia could have a detrimental effect on humans, ecosystems and vegetation. As an air pollutant, it contributes to the formation of particulate aerosols in the atmosphere, which in turn could affect human health. Furthermore, ammonia contributes to acid deposition and eutrophication leading to potential modification in soil, aquatic ecosystems, forests and vegetation. The odor threshold for NH 3 is 20 ppm in air. Eye and throat irritation are noticeable above 100 ppm, skin irritation occurs above 400 ppm, and the IDLH is 500 ppm in air. NH 3 is caustic, especially in its aqueous form. In addition, condensation of ammonia and water in cooler regions of conventional exhaust gas treatment lines downstream of the exhaust catalysts can lead to the formation of corrosive mixtures comprising the stability of the exhaust gas treatment line.

One established approach for removal of NOx from exhaust gas is “selective catalytic reduction” (SCR), in which the catalytic reduction of nitrogen oxides involves the injection of a reductant like urea or ammonia itself in the presence of an appropriate amount of oxygen to convert NOx into nitrogen and steam:

4NO+4NH₃+O₂→4N₂+6H₂O

NO+NO₂+2NH₃→2N₂+3H₂O

Accordingly, one unsolved problem of currently used exhaust gas treatment lines arises from potential “ammonia slip” from SCR catalysts in which ammonia injection is used for purging NOx.

However, even in exhaust gas treatment systems without ammonia injection systems, ammonia can be formed in the exhaust gas of gasoline engines via several routes when hydrogen gas reacts with several nitrogen oxides to form ammonia. Hydrogen is generated over precious metal sites during the so-called water gas shift reaction facilitated by periodic exhaust handling as is the case in gasoline applications. The pathway includes the reaction from carbon monoxide and water vapor and/or by steam reforming at temperatures higher than 350° C., when hydrocarbons react with water to form hydrogen. For instance, nitric oxide (NO) and nitrogen dioxide (NO₂) can react in the presence of hydrogen to generate ammonia.

The amount of ammonia formed in exhaust gas can depend on engine calibration and catalyst composition. The effective concentrations of carbon monoxide and hydrogen in the exhaust stream, the duration of rich transient conditions, air/fuel ratio, temperature and space velocity are all factors, which can contribute to the formation of ammonia. Further, the interaction of the platinum group metals (PGM) and the oxygen storage component (OSC) may also impact hydrogen formation in the water gas shift reaction.

Accordingly, although no specific final limits have been set yet for ammonia in future regulations, improvement of the already existing exhaust gas treatment systems is reasonable in order to significantly reduce ammonia tailpipe emissions of automotives in the future.

Since a high number of complex chemical reactions are already involved when pollutants like NOx, HC and CO need to be effectively removed, additional elimination of ammonia at the tailpipe of an improved exhaust gas treatment line for gasoline engines requires thorough adjusting and balancing of the efficiency of the various filter functions for the different pollutants.

For instance, the ability of an exhaust gas treatment system to remove NOx must not be compromised when ammonia is effectively purged at the tailpipe. Likewise, the removal of ammonia should not lead to the formation of significant amounts of nitrous oxide (N₂O) at the tailpipe of the exhaust gas treatment system because N₂O is also an undesirable pollutant and greenhouse gas known to substantially contribute to global warming.

These objectives are solved by the first aspect of the present invention, which is an exhaust gas treatment system for reducing ammonia emission from a gasoline engine comprising a three-way conversion catalyst (TWC) or a four-way conversion catalyst (FWC) with a particulate filter characterized in that the exhaust gas treatment system comprises an ammonia abatement catalyst comprising a selective catalytic reduction catalyst (SCR) and/or an ammonia oxidation catalyst (AMOx).

In a preferred embodiment of the exhaust gas treatment system of the present invention, the three-way conversion catalyst (TWC) or the four-way conversion catalyst (FWC) comprises a substrate and at least one catalytic washcoat present on said substrate, the catalytic washcoat comprising at least one precious metal or platinum group metal (PGM), an oxygen storage compound and a refractory metal oxide.

In another preferred embodiment, the three-way conversion catalyst (TWC) or the four-way conversion catalyst (FWC) is in close-coupled (CC) position.

In another preferred embodiment, the three-way conversion catalyst (TWC) is coated on the particulate filter to form the four-way conversion catalyst (FWC).

In another preferred embodiment, the particulate filter is not coated by the three-way conversion catalyst (TWC) and positioned downstream of the three-way conversion catalyst (TWC).

In another preferred embodiment, the ammonia abatement catalyst is positioned downstream of the three-way conversion catalyst (TWC) or the four-way conversion catalyst (FWC).

In another preferred embodiment, the ammonia abatement catalyst is in underfloor (UF) position.

In another preferred embodiment, the particulate filter is positioned downstream of the three-way conversion catalyst (TWC) and upstream of the ammonia abatement catalyst comprising the selective catalytic reduction catalyst (SCR) and/or ammonia oxidation catalyst (AMOx).

In another preferred embodiment, the ammonia abatement catalyst comprising the selective catalytic reduction catalyst (SCR) and/or the ammonia oxidation catalyst (AMOx) is configured as a stand-alone catalyst.

In another preferred embodiment, the substrate is a wall flow filter substrate.

In another preferred embodiment, the selective catalytic reduction catalyst (SCR) lacks any precious metal or platinum group metal.

In another preferred embodiment, the selective catalytic reduction catalyst (SCR) comprises a metal-promoted molecular sieve, preferably an iron-promoted or copper-promoted zeolite.

In another preferred embodiment, the ammonia oxidation catalyst (AMOx) comprises a precious metal or platinum group metal at a total loading of precious metal or platinum group metal from about 0.1 g/ft³ to about 10 g/ft³, preferably about 0.3 g/ft³ to about 5 g/ft³, more preferably about 0.5 g/ft³ to about 3 g/ft³, calculated as the total weight of precious metal or platinum group metal of the volume of the AMOx catalyst.

In another preferred embodiment, the ammonia oxidation catalyst (AMOx) comprises total precious metal or platinum group metal loading from about 0.01 wt. % to about 2 wt. %, preferably from about 0.05 wt. % to about 1 wt. %, more preferably from about 0.08 to about 0.5 wt. %, based on the weight of the dry AMOx catalyst component.

In the second aspect of the present invention, a method is provided for treating an exhaust gas stream of a gasoline engine comprising the steps of providing an exhaust gas stream from a gasoline engine comprising ammonia, and contacting the exhaust gas stream comprising ammonia with the exhaust gas treatment system of the present invention to reduce the ammonia emission in the exhaust gas stream.

In the following, the exhaust gas treatment system of the present invention is described in more detail.

As used herein, the terms “catalyst”, “catalytic function”, “catalyst component”, “catalyst material” or the like refer to a material that promotes a reaction or several reactions. Accordingly, the present invention is generally characterized by combining several catalytic functions in one exhaust gas treatment line for synergistically removing several pollutants from the tailpipe at the same time.

The individual catalytic functions are defined below in greater detail:

Most importantly, the exhaust gas treatment system must be able to remove the three major pollutants generated from a gasoline engine, including nitrogen oxides (NOx), hydrocarbons (HC) and carbon monoxide (CO). Accordingly, removal of these three most important pollutants is preferably achieved by relying on a typical three-way conversion catalyst (TWC).

The three-way layered catalyst (TWC) comprises several essential catalytic components. Preferably, the composition of the three-way conversion catalytic coating is selected to comprise a hydrocarbon (HC) oxidation component, a carbon monoxide (CO) oxidation component, and a nitrogen oxide (NOx) reduction component allowing to purge NOx, HC and CO from the exhaust gas treatment system.

In one preferred embodiment, the three-way conversion catalytic coating comprises a platinum group metal (PGM), more preferably rhodium, supported on a refractory metal oxide support, a platinum group metal, more preferably platinum, supported on an oxygen storage compound and/or stabilized alumina, and even more preferably palladium, supported on an oxygen storage compound, and, optionally, an additional promoter component.

The three-way layered catalyst or catalytic coating typically comprises platinum group metals. It is preferred that the three-way conversion catalytic coating comprises one or more platinum group metals, more preferably one or more of ruthenium, palladium, rhodium, platinum, and iridium, more preferably one or more of palladium, rhodium, and platinum, more preferably one or more of palladium and rhodium, and even more preferably palladium and rhodium.

Preferably, the three-way conversion catalyst or catalytic coating further comprises an oxygen storage compound. More preferably, the oxygen storage compound comprises cerium, more preferably comprises one or more of a cerium oxide, a mixture of oxides comprising a cerium oxide, and a mixed oxide comprising cerium, wherein the mixed oxide comprising cerium preferably additionally comprises one or more of zirconium, yttrium, neodynium, lanthanum, and praseodymium, more preferably additionally comprises one or more of zirconium, yttrium, neodynium, and lanthanum, more preferably additionally comprises zirconium, yttrium, neodynium, and lanthanum. Further, the oxygen storage compound comprising cerium may consist of two or more different mixed oxides wherein each one of these mixed oxides may comprise cerium and one or more of zirconium, yttrium, neodynium, lanthanum, and praseodymium.

More preferably, the oxygen storage compound has a porosity in the range of from 0.05 to 1.5 ml/g, more preferably in the range of from 0.1 to 1.0 ml/g, more preferably in the range of from 0.15 to 0.8 ml/g. The porosity of the oxygen storage compound is determined by physisorption of N₂ and analyzing the physisorption isotherms via BJH (Barett, Joyner, Halenda) analysis according to DIN 66134.

The three-conversion catalyst or catalytic coating further preferably comprises a refractory metal oxide support. Such refractory metal oxide support comprises aluminum, more preferably comprises one or more of an aluminum oxide, a mixture a mixture of oxides comprising an aluminum oxide, and a mixed oxide comprising aluminum, wherein the mixed oxide comprising aluminum and stabilized aluminum, more preferably additionally comprises one or more of zirconium, cerium, lanthanum, barium, and neodymium, wherein more preferably, the refractory metal oxide support comprises an aluminum oxide, more preferably a gamma aluminum oxide.

More preferably, the refractory metal oxide support has a porosity in the range of from 0.05 to 1.5 ml/g, more preferably in the range of from 0.1 to 1.0 ml/g, more preferably in the range of from 0.15 to 0.8 ml/g. The porosity of the refractory metal oxide support is determined by physisorption of N₂ and analyzing the physisorption isotherms via BJH (Barett, Joyner, Halenda) analysis according to DIN 66134.

The three-way conversion catalyst or catalytic coating further comprises a promoter. The term “promoter” as used in the context of the present invention relates to a compound, which enhances the overall catalytic activity. More preferably, the promoter comprises one or more of zirconium, barium, strontium, lanthanum, neodymium, yttrium, and praseodymium, wherein more preferably, the promoter comprises one or more of zirconium and barium. More preferably, the promoter comprises, more preferably is, one or more of a mixture of barium oxide and strontium oxide and a mixed oxide of barium and strontium.

More preferably, the three-way conversion catalytic coating comprises the platinum group (precious) metal supported on the refractory metal oxide support at a loading in the range of from 1 to 200 g/ft³, more preferably in the range of from 3 to 180 g/ft³, more preferably in the range of from 4 to 150 g/ft³ and said refractory metal oxide support at a loading in the range of from 0.1 to 3 g/ft³, more preferably in the range of from 0.15 to 2.5 g/ft³, more preferably in the range of from 0.2 to 2 g/ft³. The three-way conversion catalytic coating further comprises the platinum group (precious) metal supported on the oxygen storage compound at a loading in the range of from 1 to 200 g/ft³, more preferably in the range of from 3 to 180 g/ft³, more preferably in the range of from 4 to 150 g/ft³, and said oxygen storage compound at a loading in the range of from 0.1 to 3 g/ft³, more preferably in the range of from 0.15 to 2.5 g/ft³, more preferably in the range of from 0.2 to 2 g/ft³. The three-way conversion catalytic coating further comprises the promoter at a loading in the range of from 0.001 to 1.0 g/ft³, more preferably in the range of from 0.005 to 0.5 g/ft³, more preferably in the range of from 0.005 to 0.2 g/ft³.

Preferably, the three-way conversion catalytic coating is present at a loading in the range of from 0.1 to 5 g/in³, more preferably in the range of from 0.5 to 4 g/in³, more preferably in the range of from 0.8 to 3 g/in³. The skilled person will be familiar with determining the loadings of precious metals or platinum group metals on catalytic coatings. For instance, XRF (X-ray fluorescence) and inductively coupled plasma atomic emission spectroscopy (ICP-AES) can be used for measuring the catalytic loading.

It is also possible that the three-way conversion catalyst (TWC) comprises several washcoat layers, like for instance two washcoat layers, which are positioned consecutively on the substrate. The multiple washcoat layers can have different compositions with respect to the selection and amount of the platinum group metal (PGM), the oxygen storage component and/or the refractory metal oxide support. Three-way conversion catalysts (TWC) with several different washcoats and their preparation are for instance disclosed in WO 2014/116897 A1 and WO 2020/053350 A1, which both are herein incorporated by reference in their entirety.

In view of the stringent emission particle number emission regulations like Euro6c, removal of particulate matter emitted from gasoline engines has become a critical requirement. Therefore, the exhaust gas treatment systems of the present invention must be able to remove particulate matter from a gasoline engine based on the use of an additional particle filter, like for instance a so-called gasoline particulate filter (GPF). When a three-way conversion catalyst (TWC) is combined with an additional particulate filter function, the resulting catalyst is termed a so-called “four-way conversion catalyst” (FWC).

When a four-way conversion catalyst (FWC) is included into the exhaust gas treatment system of the present invention for filtering particulates, there are several options in the present invention to remove particulate matter from the exhaust gas stream.

One preferred option for including the particulate removal function is to include a separate particulate filter, which is uncoated by an additional catalytic function. For instance, such a bare particulate filter is not coated with a three-way conversion catalyst (TWC), or any other catalytic function except for the filter function that is capable of purging the particulate matter from the exhaust gas stream. Initial gasoline particulate removal functions included uncoated gasoline particulate filters (GPF) positioned downstream of a three-way conversion catalysts (TWC).

Another preferred option for a particulate filter function is a particulate filter, which is coated with a three-way conversion catalyst (TWC). In other words, the particulate filter is a coated particulate filter. In this embodiment, the particulate filter is used as substrate on which the three-way conversion catalyst (TWC) is coated on the surface or the pores of the particulate filter. As described in more detail below, the three-way conversion catalyst (TWC) when present on the particulate filter can be present in the form of one single washcoat, or several washcoats, like for instance two different washcoats or coatings.

The coating of the particulate filter can be present in different modes. One option is to present the three-way conversion catalyst (TWC) to the filter substrate by a so-called “in-wall coating”. Another option is to combine such in-wall coating with an additional “on-wall coating” on a wall-flow filter substrate. These modes are described in more detail below.

The term “particulate filter” has herein used, refers to a substrate sized and configured to trap particulates generated in the exhaust gas stream, preferably from a gasoline engine. The trapping of the particulate matter can occur, for example, by use of a particulate (or soot) filter, by use of a flow-through substrate having an internal tortuous path such that a change in direction of flow of the particulates causes them to drop out of the exhaust stream, by use of a metallic substrate, such as a corrugated metal carrier, or by other methods known to those skilled in the art. Suitable substrates are described in more detail below but other filtration devices may also be suitable, such as a pipe with a roughened surface that can knock particles out of the exhaust stream. A pipe with a bend may also be suitable.

Preferably, the four-way conversion catalyst according to the present invention consists of a flow-through filter substrate, more preferably a wall-flow filter substrate and a three-way conversion catalytic coating, wherein there are usually no specific restrictions to the wall-flow filter substrate, provided that the material is suitable for the intended use of the four-way conversion function including filtering particulates.

Preferably, the wall-flow filter substrate comprises, more preferably consists of, a cordierite, a silicon carbide, an aluminum titanate, or a combination thereof.

Preferably, in the four-way conversion catalyst, a three-way conversion function is present on the particulate filter by permeating the walls of the particulate filter functionality. In this preferred embodiment, there is no layering of the three-way conversion catalytic material on the surface of the walls of the particulate filter function. More preferably, in this preferred set-up, the resulting four-way conversion catalyst comprising a particulate filter function has a coated porosity that is less than that of the bare particulate filter. More preferably, the coated porosity may be between 75 and 98% of the uncoated porosity, or the coated porosity may be between 80 and 95% of the uncoated porosity, or the coated porosity may be between 80 and less than 93% of the uncoated porosity.

The three-way conversion catalyst (TWC) coating of the four-way conversion catalyst (FWC) can be preferably formed from a single washcoat composition that permeates the inlet side, the outlet side, or both, the inlet side and the outlet side of the particulate filter.

Alternatively, several three-way conversion catalyst (TWC) coatings, preferably two coatings, of the four-way conversion catalyst (FWC) can be formed from several, preferably two, washcoat compositions. Different washcoat compositions can be applied to permeate the inlet side and the outlet side. Alternatively, one single washcoat compositions or several washcoat compositions can be applied on the inlet side and the outlet side of the particulate filter.

The three-way conversion catalyst (TWC) material may be present in the four-way conversion catalyst (FWC) in an amount in the range of about 1 to about 5 g/in³ (about 60 to about 300 g/L). The uncoated porosity may be in the range of 55 to 70%. More preferably, the four-way conversion catalyst (FWC) comprises the three-way conversion catalyst (TWC) in an amount in the range of 120 to 244 g/L (about 1.0 to about 4.0 g/in³) and a porosity in the range of 55 to 70%, wherein the particulate filter function comprises a wall thickness in the range of about 152 μm (6 mils) to about 356 μm (14 mils). In this embodiment, the three-way conversion catalyst (TWC) permeates the walls of the particulate filter, while there is no layering of the catalytic material on the surface of the walls of the particulate filter. There is preferably no three-way conversion catalytic material present outside the pores of the particulate filter walls.

The four-way conversion catalyst (FWC) being a coated particulate filter can be prepared by applying the three-way conversion catalytic (TWC) coating on a particulate filter as follows:

Providing an appropriate particulate filter substrate, forming a slurry of a three-way conversion (TWC) catalytic material having a pH in the range of 2 to 7; and permeating the three-way conversion catalytic (TWC) material into the walls of the particulate filter to form the four-way conversion catalyst (FWC) with a particulate filter function such that the four-way conversion catalyst (FWC) has a coated porosity that is less than the uncoated porosity of the particulate filter. The slurry may have a dynamic viscosity in the range of about 5 to less than 40 mPas at 20° C. and solids content of 0-25 wt.-% solids. The pH may be in the range of 3 to 5. Preferably, there is no layering of the catalytic material on the surface of the walls of the particulate filter except optionally in areas of overlapped washcoat. In a preferred embodiment, there is no catalytic material outside the pores of the walls of the particulate filter. The coated porosity may be linearly proportional to a washcoat loading of the three-way conversion catalytic (TWC) material. The coated porosity may be between 75 and 98% of the uncoated porosity, or even 80 and 95% of the uncoated porosity, or even between 80 and less than 93%. Preferably, the particulate filter may comprise 200-300 cells per square inch (OPSI) and a wall thickness in the range of 6-14 mil.

Alternatively to more conventional full in-wall coatings generally helping to minimize the backpressure increase over the raw substrate, the four-way conversion catalysts (FWC) of the present invention can include four-way conversion catalysts (FWC), in which the three-way conversion catalytic coating (TWC) can be present as a conventional in-wall coating in combination with a so-called on-wall coating on a wall-flow filter substrate.

Common porous wall flow filter substrates can typically comprise an inlet end, an outlet end, a substrate axial length extending between the inlet end and the outlet end, and a plurality of passages defined by porous internal walls of the porous wall flow filter substrate. The plurality of passages comprises inlet passages having an open inlet end and a closed outlet end, and outlet passages having a closed inlet end and an open outlet end.

When the three-way conversion catalyst (TWC) is applied by in-wall coating in combination with on-wall coating, the pores of the porous internal walls comprise the three-way conversion catalyst (TWC) in the form of the conventional in-wall coating. In addition, the three-way conversion catalyst (TWC) is also applied on at least a portion of the surface of the porous internal walls, wherein the surface defines the interface between the porous internal walls and the passages. The term “the surface of the porous internal walls” is to be understood as the “naked” or “bare” or “blank” surface of the walls. Accordingly, the four-way conversion catalyst (FWC) also comprises a porous on-wall coating extending from the surface of the internal walls to the passage.

Such particular four-way conversion catalysts and their preparation are described in WO 2019/149929 A1, WO 2019/149930 A1 and WO 2020/043885 A1, which are all herein incorporated by reference in their entirety.

In order to address the additional objective of removing ammonia from the exhaust gas stream, the three-way conversion catalyst (TWC), the particulate filter, like the gasoline particulate catalyst (GPC), and/or the four-way conversion catalyst (FWC) need to be combined with a suitable ammonia abatement catalyst function.

In the exhaust gas treatment system of the present invention, the ammonia abatement catalyst function comprises a selective catalytic reduction catalyst (SCR) and/or an ammonia oxidation catalyst (AMOx) for purging ammonia from the exhaust gas tailpipe. The ammonia abatement function of the present invention will allow substantially reducing the ammonia tailpipe or, more preferably, will even allow for the elimination of any ammonia emission at the tailpipe of gasoline engines.

The ammonia abatement catalyst is preferably added downstream to the three-way conversion catalyst (TWC), the particulate filter and/or the four-way conversion catalyst (FWC). Additionally, or alternatively, the ammonia abatement catalyst in the exhaust line is preferably positioned as a stand-alone catalyst.

The ammonia abatement catalyst of the exhaust gas treatment system of the present invention can include two different catalytic functions capable of removing ammonia from the exhaust stream: A selective catalytic reduction (SCR) catalyst or an ammonia oxidation catalyst (AMOx), which are described in more detail below:

“Selective catalytic reduction” (SCR) refers to catalytic reduction of nitrogen oxides with a reductant in the presence of an appropriate amount of oxygen. Suitable reductants may be, for example, hydrocarbon, hydrogen, urea and/or even ammonia.

The SCR catalyst as used in the present invention can comprise, for example, one or more metal oxide (e.g. a mixed oxide), a molecular sieve (preferably a metal-promoted molecular sieve) or combinations thereof.

The SCR catalyst preferably comprises one or more molecular sieve materials. More preferably, the SCR catalytic material comprises 8-member ring small pore molecular sieves containing a metal promoter. As used herein, “small pore” refers to pore openings which are smaller than about 5 Angstroms (e.g., about 2-5 Å, about 2-4 Å, about 3-5 Å, or about 3-4 Å, for example, at the order of ˜3.8 Angstroms. One especially preferred 8-member ring small pore molecular sieve is an 8-member ring small pore zeolite.

The SCR catalytic material preferably comprises a zeolite, preferably a zeolite comprising a d6r unit. Thus, the SCR catalytic material can comprise a zeolite having a structure type selected from AEI, AFT, AFX, CHA, EAB, EMT, ERI, FAU, GME, JSR, KFI, LEV, LTL, LTN, MOZ, MSO, MWW, OFF, SAS, SAT, SAV, SBS, SBT, SFW, SSF, SZR, TSC, WEN, and combinations thereof. Preferred SCR catalytic materials comprise a zeolite with a structure type selected from the group consisting of CHA, AEI, AFX, ERI, KFL LEV, and combinations thereof. Especially preferred SCR catalytic materials comprises a zeolite with a structure type selected from CHA and AEI. Most preferred SCR catalytic materials comprise a zeolite with the CHA structure type.

The SCR catalytic material comprising zeolitic chabazite preferably is a naturally occurring tectosilicate mineral of a zeolite group with an approximativ formula represented by (Ca,Na₂,K₂,Mg)Al₂Si₄O₁₂·6H₂O (e.g. hydrated calcium aluminum silicate). Three synthetic forms of zeolitic chabazite that can be favorably used in the SCR catalysts of the present invention are described in “Zeolite Molecular Sieves,”” by D. W. Breck, published in 1973 by John Wiley & Sons, which is hereby incorporated by reference. The three synthetic forms reported by Breck are Zeolite K-G, described in J. Chem. Soc., p. 2822 (1956), Barrer et al., Zeolite D, described in British Patent No. 868,846 (1961), and Zeolite R, described in U.S. Pat. No. 3,030, to Milton, which are all herein incorporated by reference. Synthesis of another synthetic form of zeolitic chabazite, SSZ-13, is described in U.S. Pat. No. 4,544,538 to Zornes, which is herein incorporated by reference. A method of making yet another synthetic molecular sieve having chabazite structure, SAPO-44, is described in U.S. Pat. No. 6,162,415 to Liu et al., which is herein incorporated by reference.

The ratio of silica to alumina in molecular sieves useful as SCR catalytic materials in the present invention can vary over a wide range. Preferred molecular sieves useful as SCR catalytic materials have a silica to alumina molar ratio (SAR) in the range of 2 to 300, including 5 to 250, 5 to 200, 5 to 100, and 5 to 50. More preferably, the molecular sieve has a silica to alumina molar ratio (SAR) in the range of 10 to 200, 10 to 100, 10 to 75, 10 to 60, 10 to 50, 15 to 100, 15 to 75, 15 to 60, 15 to 50, 20 to 100, 20 to 75, 20 to 60, and 20 to 50. Even more preferably, with regard to the molecular sieve having any of the immediately preceding SAR ranges, the spherical particle of the molecular sieve has a particle size d₅₀ in the range of about 1.0 to about 5 microns, and more specifically, about 1.0 to about 3.5 microns, and the individual crystals of a molecular sieve component have a crystal size in the range of about 100 to about 250 nm.

Metal-promoted zeolite catalysts including, among others, iron-promoted and copper-promoted zeolite catalysts, for the selective catalytic reduction of nitrogen oxides with for instance ammonia are preferred. The promoter metal can be selected from Cu, Fe, Co, Ni, La, Ce, Mn, V, Ag, and combinations thereof. Preferred promoter metals are Cu, Fe, or combinations thereof. Preferred SCR catalysts do not contain any precious metal or platinum group metal, like for instance rhodium, palladium and/or platinum. Metal-promoted, particularly copper promoted aluminosilicate zeolites having the CHA structure type and a silica to alumina molar ratio greater than 1, have recently solicited a high degree of interest as catalysts for the selective catalytic reduction of nitrogen oxides in lean burning engines using nitrogenous reductants. The promoter metal content in such preferred catalysts, calculated as the oxide, is preferably at least about 0.1 wt. %, reported on a volatile-free basis. Preferably, the promoter metal comprises Cu, and the Cu content, calculated as CuO is in the range of up to about 10 wt. %, or more preferably 9, 8, 7, 6, 5, 4, 3, 2, 1, 0.5, and 0.1 wt. %, in each case based on the total weight of the calcined zeolite component reported on a volatile free basis. The Cu content, calculated as CuO, can be in the range of about 1 to about 4 wt. %.

One exemplary molecular sieve that can be useful as an SCR catalytic material is an aluminophosphate. Types of aluminophosphates include silicoaluminophosphate (SAPO), metallic aluminophosphate (MeAPO), and metallic silicoaluminophosphate (MeSAPO). The preparation of a synthetic form of an exemplary aluminophosphate molecular sieve, silicoaluminophosphate 34 (SAPO-34), is described in U.S. Pat. No. 4,440,871 to Lok et al. and 7,264,789 to Van Den et al, which are hereby incorporated by reference. A method of making yet another synthetic molecular sieve, SAPO-44, is described in U.S. Pat. No. 6,162,415 to Liu et al., which is hereby incorporated by reference.

The SCR catalyst of the present invention preferably comprises a metal oxide, e.g., a mixed oxide. As used herein, the term “mixed oxide” refers to an oxide that contains cations of more than one chemical element or cations of a single element in several states of oxidation. Mixed oxides that are suitable as SCR catalysts can include Fe/titania (e.g. FeTiO₃), Fe/alumina (e.g. FeAl₂O₃), Mg/titania (e.g. MgTiO₃), Mg/alumina (e.g. MgAl₂O₃), Mn/alumina, Mn/titania (e.g. MnOₓ/TiO₂) (e.g. MnOₓ/Al₂O₃), Cu/titania (e.g. CulTiO₃), Ce/Zr (e.g. CeZrO₂), Ti/Zr (e.g. TiZrO₂) and mixtures thereof. Additional examples of mixed oxides as SCR catalysts can be found in U.S. Patent Application Publiation No. 2001/0049339 to Schafer-Sindelindger et al. and U.S. Pat. No. 4,518,710 to Brennan et al., 5,137,855 to Hegedus et al., 5,476,828 to Kapteijn et al., U.S. Pat. No. 8,685,882 to Hong et al., and 9,101,908 to Jurng et al., which all incorporated by reference herein in their entireties.

The SCR catalyst can comprise one or more vanadium-containing components. Such compositions are generally referred to herein as “vanadia-based compositions”. In such embodiments, the vanadium can be in various forms, e.g., including but not limited to, free vanadium, vanadium ion, or vanadium oxides (vanadia), such as vanadium pentoxide (V₂O₅). As used herein, “vanadia” or “vanadium oxide” is intended to cover any oxide of vanadium, including vanadium pentoxide. A vanadia-based composition preferably comprises a mixed oxide comprising vanadia. The amount of vanadia in the mixed oxide can vary and, preferably, ranges from about 1 to about 10 percent by weight, based on the total weight of the mixed oxide. For example, the amount of vanadia can be at least 1 percent, at least 2 percent, at least 3 percent, at least 4 percent, at least 5 percent, or at least 6 percent, with an upper limit of about 10 percent by weight or no more than 10 percent, no more than 9 percent, no more than 8 percent, no more than 7 percent, no more than 6 percent, no more than 5 percent, or no more than 4 percent, with a lower limit of about 1 percent by weight.

Preferred SCR compositions comprise vanadium supported on a refractory real oxide such as alumina, silica, zirconia, titania, ceria, and combinations thereof are described in U.S. Pat. No. 4,010,238 to Shiraishi et al and 4,085,193 to Nakajima et al., as well as in U.S. Patent Application Publication No. 2017/0341026 to Chen et al., which are incorporated by reference herein in their entireties. In other preferred embodiments, the SCR catalyst comprises a mixed oxide comprising vanadia/titania (V₂O₅/TiO₂), e.g., in the form of titania onto which vanadia has been dispersed. The vanadia/titania can optionally be activated or stabilized with tungsten (e.g. WO₃) to provide V₂O₅/TiO₂/WO₃, e.g., in the form of titania onto which V₂O₅ and WO₃ have been dispersed. The vanadia is not always truly in the form of a mixed metal oxide, rather, the metal oxide components (e.g., titania and vanadia) may be present as discrete particles. The amount of tungsten in such embodiments can vary and can range, e.g., from about 0.5 to about 10 percent by weight based on the total weight of the mixed oxide. For example, the amount of tungsten can be at least 0.5 percent, at least 1 percent, at least 2 percent, at least 3 percent, at least 4 percent, at least 5 percent, or at least 6 percent, with an upper limit of about 10 percent by weight or no more than 10 percent, no more than 9 percent, no more than 8 percent, no more than 7 percent, no more than 6 percent, no more than 5 percent, or no more than 4 percent, with a lower limit of about 0.5 percent by weight.

Exemplary vanadia-based SCR compositions can comprise components including, but not limited to, V₂O₅/TiO₂, V₂O₅/WO₃/TiO₂/SiO₂, or combinations thereof. Additional vanadium-containing SCR catalyst compositions are described, for example, in U.S. Pat. No. 4,782,039 to Lindsey and 8,975,206 to Schermanz et al., as well as International Application Publication No. WO 2010/121280 to Schermanz et al., which are incorporated herein by reference in their entireties.

Certain vanadia-based SCR compositions can comprise other active components (e.g., other metal oxides). For example, in some embodiments, vanadia-based SCR compositions suitable for use in the disclosed systems comprise vanadia and antimony. Such a vanadia-based SCR composition, in certain embodiments, comprises a composite oxide comprising vanadium and antimony, which can be supported on a refractory metal oxide (e.g., TiO₂, SiO₂, WO₃, Al₂O₃, ZrO₂, or a combination thereof). Exemplary vanadia-based SCR compositions comprising vanadia and antimony are disclosed in U.S. Pat. No. 4,221,768 to Inoue et al., International Application Publication No. WO 2017/101449 to Zhao et al., and International Application Nos. PCT/CN2016/113637, filed Dec. 30, 2016; PCT/CN2015/076895, filed Apr. 17, 2015, and PCT/CN2015/097704, filed Dec. 17, 2015, all of which are incorporated herein by reference in their entireties. In certain embodiments, the SCR catalyst can comprise a mixture of a vanadium-based SCR composition and a molecular sieve.

The term “ammonia oxidation catalyst” (AMOx) as used herein refers to a catalyst containing one or more metals suitable to convert excess ammonia in the exhaust system into nitrogen, and which is generally supported on a support material. Ammonia oxidation (AMOx) generally refers to a process in which ammonia is preferably reacted with oxygen to produce N₂. The ammonia oxidation catalyst AMOx is capable of predominantly converting the excess ammonia to N₂, with minimal nitrogen oxide by-products, like nitrogen oxides NOx, preferably at a wide range of temperatures, where ammonia slip could otherwise escape in the vehicles driving cycle. Accordingly, the AMOx catalyst also produces minimal N₂O, which is an undesired potent greenhouse gas.

The composition of the AMOx catalyst is not particularly limited, and various compositions known to be suitable for this purpose can be employed in the context of the disclosed exhaust gas treatment systems.

It is preferred that the ammonia oxidation catalytic component generally is a composition, preferably a physical mixture, comprising one or more platinum group metals supported on a refractory metal oxide and a molecular sieve material, preferably a molecular sieve material comprising copper or iron on a small pore molecular sieve material, the latter even more preferably having a maximum ring size of eight tetrahedral atoms.

The AMOx catalyst can preferably include a supported platinum group metal component, which is effective to remove ammonia from the exhaust gas stream. Preferred platinum group metal components include ruthenium, rhodium, iridium, palladium, platinum, silver or gold. The platinum group metal component can include physical mixtures and/or chemical and/or atomically doped combinations of ruthenium, rhodium, iridium, palladium, platinum, silver and gold. In very preferred embodiments, the AMOx catalyst comprises a precious metal or platinum group metal (PGM) such as platinum, palladium, rhodium, or combinations thereof. It is especially preferred that the AMOx catalyst comprises platinum. It is very preferred that the platinum group metal, most preferably platinum, is present in an amount in the range of about 0.008% to about 2% by wt (metal), based on Pt group metal support loading.

The AMOx catalytic function according to the present invention comprises a total loading of precious metal or platinum group metal from about 0.1 g/ft³ to about 10 g/ft³, preferably about 0.3 g/ft³ to about 5 g/ft³, more preferably about 0.5 g/ft³ to about 3 g/ft³, even more preferably about 0.8 g/ft³ to about 2 g/ft³, calculated as the total weight of precious metal or platinum group metal over the volume of the AMOx catalyst. Alternatively or additionally, the AMOx composition disclosed herein comprises total precious metal or platinum group metal loading from about 0.01 wt. % to about 2 wt. %, preferably from about 0.05 wt. % to about 1 wt. %, more preferably from about 0.08 to about 0.5 wt. %, based on the weight of the dry AMOx catalyst component.

Preferably, the precious metal component or platinum group metal of the ammonia oxidation catalytic component comprises, preferably consists of, platinum (Pt). The ammonia oxidation catalyst comprises or consists of the platinum (Pt) component in an amount in the range of about 0.5 g/ft³ to about 10 g/ft³, more preferably in the range of about 0.01 wt. % to about 2 wt. %, or alternatively, at total loadings of platinum and/or amounts of platinum as defined above for the generic precious metal or platinum group metal.

Preferably, the precious metal component or platinum group metal of the ammonia oxidation catalytic component comprises, preferably consists, of palladium (Pd). The ammonia oxidation catalyst comprises or consists of the palladium (Pd) component in an amount in the range of about 0.5 g/ft³ to about 10 g/ft³, more preferably in the range of about 0.01 wt. % to about 2 wt. %, or alternatively, at total loadings of palladium and/or amounts of palladium as defined above for the generic precious metal or platinum group metal.

Preferably, the precious metal component or platinum group metal of the ammonia oxidation catalytic component comprises, preferably consists of, rhodium (Rh). The ammonia oxidation catalyst comprises or consists of the rhodium (Rh) component in an amount in the range of about 0.5 g/ft³ to about 10 g/ft³, more preferably in the range of about 0.01 wt. % to about 2 wt. %, or alternatively, at total loadings of rhodium and/or amounts of rhodium as defined above for the generic precious metal or platinum group metal.

The skilled person will be familiar with determining the loadings of precious metals or platinum group metals on catalytic coatings. For instance, XRF (X-ray fluorescence) and inductively coupled plasma atomic emission spectroscopy (ICP-AES) can be used for measuring the catalytic loading.

The precious metal or platinum group metal of the AMOx catalyst of the present invention is preferably supported, for instance on a high surface area refractory metal oxide support. Examples of suitable high surface area refractory metal oxides include, but are not limited to, alumina, silica, titania, ceria, and zirconia, as well as physical mixtures, chemical combinations and/or atomically doped combinations thereof. The refractory metal oxide may contain a mixed oxide such as silica-alumina, amorphous or crystalline aluminosilicates, alumina-zirconia, alumina-lanthana, alumina-chromia, alumina-baria, alumina-ceria, and the like. An exemplary refractory metal oxide comprises high surface area γ-alumina, preferably having a specific surface area of about 50 to about 300 m²/g.

Preferred refractory metal oxide supports useful in the AMOx compositions of the present invention are alumina or doped alumina materials, such as Si-doped alumina materials (including, but not limited to 1-10% SiO₂—Al₂O₃), titania or doped titania materials, such as Si-doped titania materials (including, but not limited to 1-15% SiO₂—TiO₂) or zirconia or doped zirconia materials, such as Si-doped ZrO₂ (including, but not limited to 5-30% SiO₂—ZrO₂).

High surface area metal oxide supports, such as alumina or titania support materials, typically exhibit a total surface area (BET) of about 50 m²/g to about 400 m²/g, and preferably from about 60 m²/g to about 350 m²/g, for example from about 90 m²/g to about 250 m²/g.

The refractory metal oxide support material preferably has total pore volume (BET) in the range of about 0.3 to about 1.5 cm³/g. The active alumina has mean pore diameter (BET) in the range of about 2 to about 50 nm.

The AMOx catalyst can include at least a zeolitic or non-zeolitic molecular sieve. In specific embodiments, the zeolitic or non-zeolitic molecular sieve has a framework type preferably selected from, but not limited to, CHA, AEI, BEA, MFI, FAU, MOR, AFX and LTA. In specific embodiments, the zeolitic or non-zeolitic molecular sieve may be physically mixed with at least a metal oxide supported PGM component. In one specific embodiment, the PGM may be distributed on the external surface or in the channels, cavities or cages of the zeolitic or non-zeolitic molecular sieve.

In one or more embodiments, the ammonia oxidation catalyst (AMOx) comprises at least a zeolite component and base metal component selected from one or both of a copper and iron component.

In one or more embodiments, the AMOx catalyst comprise a catalyst coating with a bottom layer of a Pt supported on a high surface area metal oxide; and further comprise a second catalyst coating with a layer of Cu-CHA or Cu-AEI.

In one or more embodiments, the ammonia oxidation catalyst (AMOx) comprises at least one inorganic metal oxide material selected from vanadium oxide and molybdenum oxide.

In one or more embodiments, the ammonia oxidation catalyst (AMOx) has particle size distribution D50 from about 1 micron to about 10 microns, and/or the ammonia oxidation catalyst has particle size distribution d₉₀ from about 2 microns to about 30 microns.

In one or more embodiments, the ammonia oxidation catalyst (AMOx) has a surface area (BET) in the range of about 50 to about 700 m²/g. In one or more embodiments, the ammonia oxidation catalyst has mean pore volume (BET) in the range of about 0.3 to about 1.5 cm³/g. In one or more embodiments, the ammonia oxidation catalyst has mean pore diameter (BET) in the range of about 2 to about 50 nm. In one or more embodiments, the ammonia oxidation catalyst is coated on a substrate with a dry gain from about 0.3 to about 3.0 g/in³.

The individual catalytic functions of the exhaust gas treatment system of the present invention as already described above can be combined according to the following configurations:

The TWC is most preferably positioned upstream in the exhaust gas treatment line, followed “downstream” by the other catalytic components or functions.

The terms “upstream” and “downstream” as used in the present invention have its ordinary meaning in the art, and are therefore also used herein to generally denote the relative position of a catalytic function or component when compared to the relative position of another catalytic function or component in the exhaust gas system based on the flow direction of the exhaust gas stream.

If there is an additional particulate filter, like a gasoline particulate catalyst or filter (GPC), the three-way conversion catalyst (TWC) and the particulate filter, like the gasoline particulate filter (GPC) effectively form together a “four-way conversion catalyst (FWC), which is also most preferably positioned “upstream” in the present invention.

Further, it is preferred in the present invention that the three-way conversion catalyst (TWC) is also most preferably close-coupled. The term “close-coupled” indicates a position, which is located in fluid communication with and shortly downstream the engine outlet, preferably the gasoline engine outlet, preferably within 50 cm, more preferably within 30 cm and most preferably within 20 cm after the engine outlet. Therefore, in the context of the present invention, a “close-coupled”position is understood as commonly understood in the art, which is for instance substantially closer to the engine than in traditional “underfloor” positions (which are beneath the floor of a vehicle). Generally, although not limited thereto, such a “close-coupled” position is preferably within the engine compartment, which is normally beneath the hood of a vehicle, and adjacent to the exhaust manifold. Therefore, a catalyst positioned in “close-coupled” position is commonly exposed to high temperature exhaust gas immediately exiting the engine after the engine has warmed up, and thus often serves to reduce hydrocarbon emissions during cold start, which is typically the period immediately following the start of the engine from ambient conditions.

If there is a four-way conversion catalyst (FWC) in the exhaust gas treatment line, the four-way conversion catalyst (FWC) is also positioned most preferably “close-coupled”, like the three-way conversion catalyst (TWC) also most preferably is.

If an uncoated particulate filter is used in the exhaust gas treatment line of the present invention, the uncoated particulate filter is preferably positioned downstream of the three-way conversion catalyst (TWC), for instance in close distance to the TWC, for instance mounted in the same canning, while the TWC is close-coupled, i.e. it is most preferred that the TWC is followed downstream by the particulate filter, while both are positioned close-coupled.

According to the present invention, the three-way conversion catalyst (TWC), the particulate filter, like the gasoline particulate catalyst (GPC) and/or the four-way conversion catalyst (FWC) are followed downstream in a preferred configuration by the ammonia abatement catalyst comprising a selective catalytic reduction catalyst (SCR) and/or an ammonia oxidation catalyst (AMOx). In other words, the relative position of the ammonia abatement catalyst comprising the selective catalytic reduction catalyst (SCR) and/or the ammonia oxidation catalyst (AMOx) is preferably after the three-way conversion catalyst (TWC), the particulate filter, like the gasoline particulate catalyst (GPC), and/or the four-way conversion catalyst (FWC) with respect to the direction of the exhaust gas stream.

The position of the ammonia abatement catalyst comprising a selective catalytic reduction catalyst (SCR) and/or an ammonia oxidation catalyst (AMOx) is not only preferably positioned downstream of the three-way conversion catalyst (TWC), the particulate filter, like the gasoline particulate catalyst (GPC) and/or the four-way conversion catalyst (FWC) but most preferably also positioned “under-floor”.

The term “under-floor” as used in the present invention has the technical meaning used in the art. The term “under-floor” relates to a location below the vehicle cabin. Further, the term “under-floor” indicates a substantial distance between a close-coupled catalyst function and a catalytic function located “under-floor”, which preferably is in fluid communication with the close-coupled catalyst function, of between 50 cm-150 cm, preferably 75-150 and most preferably 100 150 cm. Accordingly, a catalyst function positioned “under-floor” is more distant from the engine than a catalyst function positioned “close-coupled” and therefore requires lower temperature resistance than the close-coupled catalytic function.

Two very preferred configurations of the present invention are based on a three-way conversion catalyst (TWC) coated on a particulate filter, positioned upstream and close-coupled, followed by either a selective catalytic reduction catalyst (SCR) or an ammonia oxidation catalyst (AMOx), both located downstream and in under-floor position.

Two other preferred configurations of the present invention are based on a four-way conversion catalyst (FWC) including a separate, uncoated particulate filter positioned upstream and close-coupled, comprising a three-way conversion catalyst (TWC) and a separate, uncoated particulate catalyst, located downstream of the TWC, followed by either a selective catalytic reduction catalyst (SCR) or an ammonia oxidation catalyst (AMOx), both located downstream and in under-floor position.

The various catalytic components or functions, including the three-way conversion catalyst (TWC) or the four-way conversion catalyst (FWC), optionally the gasoline particulate catalyst (GPC), and the ammonia abatement catalyst comprising the selective catalytic reduction catalyst (SCR) and/or the ammonia oxidation catalyst (AMOx) are positioned on an appropriate substrate to form the exhaust line of the exhaust gas treatment system for gasoline engines.

Suitable substrates are 3-dimensional, having a length, a diameter and a volume, like a cylinder. The shape does not necessarily have to conform to a cylinder. The length is an axial length defined by an inlet end and an outlet end. The substrate of the present invention may be constructed of any material typically used for preparing automotive catalysts and will typically comprise a metal or ceramic honeycomb structure. Preferably, the substrate provides a plurality of wall surfaces upon which the washcoat composition is applied and adhered, thereby acting as a substrate for the catalyst composition.

According to one or more embodiments, the substrate for the disclosed composition(s) may be-constructed of any material typically used for preparing automotive catalysts and will typically comprise a metal or ceramic honeycomb structure. The substrate typically provides a plurality of wall surfaces upon which the washcoat composition is applied and adhered, thereby acting as substrate for the catalyst composition.

The substrate of the present invention can be a typical monolithic substrate of the type having fine, parallel gas flow passages extending there through from an inlet or an outlet face of the substrate such that passages are open to fluid flow there through (“flow-through substrate”).

The flow-through substrate can be a monolithic substrate including a flow-through honeycomb monolithic substrate. The skilled person is familiar with flow-through substrates, which generally have fine, parallel gas flow passages extending from an inlet end to an outlet end of the substrate such that passages are open to fluid flow. The passages, which are essentially straight paths from their fluid inlet to their fluid outlet, are defined by walls on which a catalytic coating can be disposed so that gases flowing through the passages contact the catalytic material. The flow passages of the flow-through substrate are thin-walled channels, which can be of any suitable cross-sectional shape and size, such as trapezoidal, rectangular, square, sinusoidal, hexagonal, oval, circular or the like. The flow-through substrate can be ceramic or metallic as further described below. Flow-through substrates can, for example, have a volume of from about 50 in³ to about 1200 in³, a cell density (inlet openings) of from about 60 cells per square inch (cpsi) to about 1200 cpsi or about 200 to about 900 cpsi, or for example from about 300 to about 600 cpsi and a wall thickness of from about 50 to about 400 microns or about 100 to about 200 microns.

Suitable substrates can be ceramic substrates, which are made of any suitable refractory material, e.g. cordierite, cordierite-α-alumina, aluminum titanate, silicon titanate, silicon carbide, silicon nitride, zircon mullite, spodumene, alumina-silica-magnesia, zircon silicate, sillimanite, a magnesium silicate, zircon, petalite, α-alumina, an aluminosilicate and the like.

Substrates suitable in the present invention can also be metallic, comprising one or more metals or metal alloys. A metallic substrate may include any metallic substrate, such as those with openings or “punch-outs” in the channel walls. The metallic substrates may be employed in various shapes such as pellets, corrugated sheet or monolithic foam. Specific examples of metallic substrates include heat-resistant, base-metal alloys, especially those in which iron is a substantial or major component. Such alloys may contain one or more of nickel, chromium, and aluminum, and the total of these metals may advantageously comprise at least about 15 wt. % of the alloy, for instance, about 10 to about 25 wt. % chromium, about 1 to about 8 wt. % of aluminum, and from 0 to about 20 wt. % of nickel, in each case based on the weight of the substrate. Examples of metallic substrates include those having straight channels, those having protruding blades along the axial channels to disrupt gas flow and to open communication of gas flow between channels.

The most preferred substrates in the present invention are wall flow filter substrates. Wall flow filter substrates as understood by the skilled person have a plurality of fine, substantially parallel gas flow passages extending along the longitudinal axis of the substrate where, typically, each passage is blocked at one end of the substrate body, with alternate passages blocked at opposite end faces (“wall flow filter”). Suitable flow-through and wall-flow substrates are also taught, for example, in International Application Publication No. WO 2016/070090, which is incorporated herein by reference in its entirety.

It is preferred that the various catalytic functions or catalytic components are provided by applying a catalytic coating to the substrate as a washcoat.

As used herein and as described in Heck, Ronald and Robert Farrauto, Catalytic Air Pollution Control, New York: Wiley-Interscience, 2002, pp. 18-19, a washcoat layer comprises a compositionally distinct layer of material disposed on the surface of a monolithic substrate or optionally on an underlying washcoat layer. A washcoat typically is typically comprised of a high surface area carrier, for example aluminum oxide, and catalytic components such as a platinum group metal or other precious metal. A catalytic function or material can contain one or more washcoat layers, and each washcoat layer can have unique chemical catalytic functions depending on its exact composition.

Accordingly, the SCR component and the AMOx catalyst component of the present invention can be preferably applied in the form of one, two or even more washcoat layers. The washcoat layer(s) is/are coated upon and adhered to a suitable substrate.

For example, a washcoat layer of a composition containing an AMOx catalyst component may be formed by preparing a mixture or a solution of a precious metal or a platinum group metal precursor, preferably platinum, in a suitable solvent, e.g. water. Generally, from the point of view of economics and environmental aspects, aqueous solutions of soluble compounds or complexes of the precious metal, or platinum group metal, like platinum, are preferred. Typically, the precious metal or platinum group metal precursor is utilized in the form of a compound or complex to achieve dispersion of the precursor on the support. For purposes of the present invention, the term “precious metal precursor” or “platinum group metal precursor” means any compound, complex, or the like which, upon calcination or initial phase of use thereof, decomposes or otherwise converts to a catalytically active form. Suitable complexes or compounds preferably include, but are not limited to platinum chlorides (e.g. salts of [PtCl4]²⁻, [PtCl6]²⁻), platinum hydroxides (e.g. salts of [Pt(OH) 6]²⁻), platinum amines (e.g. salts of [Pt(NH₃)₄]²⁺,]Pt(NH₃)₄]⁴⁺), platinum hydrates (e.g. salts of [Pt(OH₂)₄]²⁺), platinum bis(acetylacetonates), and mixed compounds or complexes (e.g. [Pt(NH₃)₂(Cl)₂]). A representative commercially available platinum source is 99% ammonium hexachloroplatinate from Strem Chemicals, Inc., which may contain traces of other precious metals. However, it will be understood that this invention is not restricted to platinum precursors of a particular type, composition, or purity. The skilled person will also be familiar with similar complex and compound precursors for precious metals or platinum group metals derived from metals other than platinum.

A mixture or solution of the precious metal precursor or platinum group metal precursor is added to the support by one of several chemical means. These include impregnation of a solution of the precursor onto the support, which may be followed by a fixation step incorporating acidic component (e.g. acetic acid) or a basic component (e.g. ammonium hydroxide). This wet solid can be chemically reduced or calcined or be used as is. Alternatively, the support may be suspended in a suitable vehicle (e.g. water) and reacted with the precursor in solution. This latter method is more typical when the support is a zeolite, and it is desired to fix the precursor to ion-exchange sites in the zeolite framework. Additional processing steps may include fixation by an acidic component (e.g. acetic acid) or a basic component (e.g. ammonium hydroxide), chemical reduction, or calcination.

In one or more embodiments, utilizing washcoat layers of a SCR catalyst function, the layer can contain a zeolitic or non-zeolitic molecular sieve on which has been distributed a metal from one of the groups VB, VIB, VIIB, VIIIB, IB, or IIB of the periodic table. An exemplary metal of this series is copper. Exemplary molecular sieves include but are not limited to zeolites having one of the following crystal structures CHA, BEA, FAU, MOR, and MFI. A suitable method for distributing the metal on the zeolite is to first prepare a mixture or a solution of the metal precursor in a suitable solvent, e.g. water. Generally, from the point of view of economics and environmental aspects, aqueous solutions of soluble compounds or complexes of the metal are preferred. For purposes of the present invention, the term “metal precursor” means any compound, complex, or the like which can be dispersed on the zeolite support to give a catalytically active metal component. For the exemplary Group IB metal copper, suitable complexes or compounds include, but are not limited to anhydrous and hydrated copper sulfate, copper nitrate, copper acetate, copper acetylacetonate, copper oxide, copper hydroxide, and salts of copper amines (e.g. [Cu(NH₃)₄]²⁺). A representative commercially available copper source is 97% copper acetate from Strem Chemicals, Inc., which may contain traces of other metals, particularly iron and nickel. However, it will be understood that this invention is not restricted to metal precursors of a particular type, composition, or purity. The molecular sieve can be added to the solution of the metal component to form a suspension. This suspension can be allowed to react so that the copper component is distributed on the zeolite. This may result in copper being distributed in the pore channels as well as on the outer surface of the molecular sieve. Copper may be distributed as copper (II) ions, copper (I) ions, or as copper oxide. After the copper is distributed on the molecular sieve, the solids can be separated from the liquid phase of the suspension, washed, and dried. The resulting copper-containing molecular sieve may also be calcined to fix the copper.

To apply a washcoat layer according to one or more embodiments of the invention, finely divided particles of a catalyst, consisting of the SCR component, the ammonia oxidation (AMOx) catalyst, or a mixture thereof, are suspended in an appropriate vehicle, e.g., water, to form a slurry. Other promoters and/or stabilizers and/or surfactants may be added to the slurry as mixtures or solutions in water or a water-miscible vehicle. In one or more embodiments, the slurry is comminuted to result in substantially all of the solids having particle sizes of less than about 10 microns, i.e., in the range of about 0.1-8 microns, in an average diameter. The comminution may be accomplished in a ball mill, continuous Eiger mill, or other similar equipment. In one or more embodiments, the suspension or slurry has a pH of about 2 to less than about 7. The pH of the slurry may be adjusted if necessary, by the addition of an adequate amount of an inorganic or an organic acid to the slurry. The solids content of the slurry may be, e.g., about 20-60 wt. %, and more particularly about 35-45 wt. %. The substrate may then be dipped into the slurry, or the slurry otherwise may be coated on the substrate, such that there will be deposited on the substrate a desired loading of the catalyst layer. Thereafter, the coated substrate is dried at about 100° C. and calcined by heating, e.g., at 300-650° C. for about 1 to about 3 hours. Drying and calcination are typically done in air. The coating, drying, and calcination processes may be repeated if necessary, to achieve the final desired gravimetric amount of the catalyst washcoat layer on the support. In some cases, the complete removal of the liquid and other volatile components may not occur until the catalyst is placed into use and subjected to the high temperatures encountered during operation.

After calcining, the catalyst washcoat loading can determined through calculation of the difference in coated and uncoated weights of the substrate. As will be apparent to those of skill in the art, the catalyst loading can be modified by altering the solids content of the coating slurry and slurry viscosity. Alternatively, repeated immersions of the substrate in the coating slurry can be conducted, followed by removal of the excess slurry as described above.

The catalysts and exhaust gas treatment systems disclosed in the present application can be used in exhaust gas generated from gasoline engines for reducing ammonia emissions.

More importantly, the exhaust gas treatment systems of the present invention allow removing ammonia from the exhaust treatment line generated by a gasoline engine either by the use of an additional oxidation catalyst like an AMOx catalyst or the use of an additional selective catalytic reduction catalyst (SCR) positioned in the exhaust line. At the same time, NOx purge is not comprised and/or no excessive N₂O is formed at the tailpipe when the exhaust gas treatment systems of the present invention are used. In consequence, the present invention provides an effective removal function for ammonia for exhaust gas treatment lines generated from a gasoline engine, while the purge of NOx, HC, CO and particulate matter remains excellent, in particular removal of NOx and/or N₂O at the tailpipe is not comprised by the addition of the ammonia removal function.

### EXAMPLES

Three different system configurations were validated in the experiments using a Euro 6 calibrated vehicle on a chassis dyno test facility at the Hannover Engine Laboratory (HEL).

The vehicle was equipped with the requisite analytical instruments positioned directly upstream of the close-coupled catalyst, after the gasoline particle filter (GPF) and after the last filter component in underfloor position.

These instruments included, but may not be limited, to Fourier Transformed Infrared (FT-IR) spectrometers mainly to capture NH 3 emissions directly after the engine and before the first catalyst (engine out), after the GPF (Mid pipe) and downstream of the underfloor catalyst (tailpipe).

The test cycle used in all experiments was the WLTC test protocol. The results are also valid for other relevant test cycles as real driving emissions (RDE) or FTP test cycles.

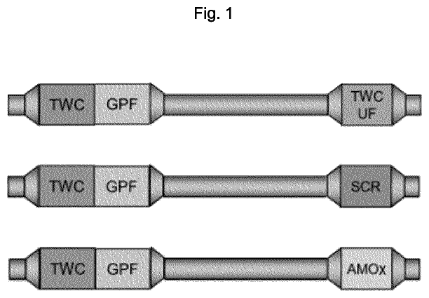

Three different exhaust gas filter systems (System 1, 2, and 3) were studied. The basic configurations of the three Systems 1 to 3 were as shown in FIG. 1 and as explained in more detail below.

System 1 (TWC+GPF+TWC) comprised a three-way conversion catalyst (TWC) in the closed-coupled position with a PGM-loading of 80 g/ft³ and 1.25 L volume, a GPF (1.16 L) uncoated and mounted directly behind the TWC in the same canning, followed by a second three-way conversion catalyst (uF-TWC, 1.2 L) in the under-floor position, which is generally of much lower content of precious metal (up to 45 g/ft³) given that the latter is mainly for clean-up purposes. The downstream catalyst was also placed in a separate canning and was separated from the up-stream canning using piping with a specific length as required for the real system application on the vehicle. System 1 depicts a conventional configuration as applied in gasoline applications and serves as the reference system.

System 2 (TWC+GPF+SCR) was composed of the same three-way conversion catalyst (TWC) in the closed-coupled position, and the same GPF as used in system 1, followed by a selective catalyst reduction (SCR) formulation in the under-floor position. The SCR catalyst was a conventional Cu-laden zeolite-containing catalyst as used in common diesel system applications and was free of precious metal. The position of the downstream SCR catalyst was such that it was equidistant to the TWC+GPF canning of System 1, so that gaseous emissions and temperatures reaching the under-floor position were similar to those experienced by the downstream TWC in System 1.

System 3 (TWC+GPF+AMOx) was composed of the same three-way conversion catalyst (TWC) in the closed-coupled position and the same GPF as used in System 1 and 2, followed by an ammonia oxidation catalyst (AMOx) formulation in the under-floor position. The AMOx catalyst was a conventional Cu-laden zeolite-containing catalyst and contained precious metal at very low loadings of 2 to 10 g/ft³. The position of the downstream AMOx catalyst was such that it was equidistant to the TWC+GPF canning used in Systems 1 and 2, resulting in similar gaseous emissions and temperatures at the under-floor position.

Oven aging was done in an in-house oven equipped with several gas lines for simultaneous dosage of different gases under controlled flow conditions. All catalysts were aged separately given that each monolith serves a different purpose and is exposed to different temperatures in the system configuration as applied in this study.

The three-way conversion catalyst (TWC) in the closed-coupled position was aged for 4 h at 1100° C. The second three-way conversion catalyst (TWC) positioned under-floor of System 1 was aged for 5 h at 950° C. in the same oven. The SCR catalyst of System 2 and the AMOx catalyst of System 3 were aged for 16 h at 750° C., respectively. The aged monoliths were canned and placed in the respective systems as described in the configurations as discussed above.

### Example 1: Ammonia Tailpipe Emission Under WLTC Heavy Drive Load

In Example 1, the performance characteristics of the three different configurations were studied under worldwide-harmonized light duty test procedure (WLTC, heavy drive load) using a Euro6 vehicle as explained above with respect to ammonia emission levels present at the tailpipe of the respective exhaust gas treatment systems.

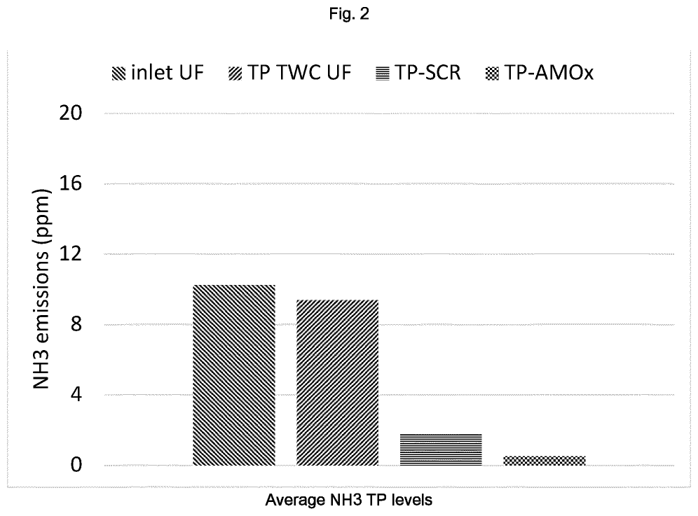

As shown in FIG. 2, it was found that all three additional catalyst functions positioned underfloor (TWC−UF, SCR−UF and AMOx−UF) allowed reducing ammonia emission relative to the ammonia emission measured at the inlet of the catalyst function positioned underfloor.

However, while the additional three-way conversion catalyst (TWC) of System 1 positioned underfloor allowed only a relatively limited reduction of ammonia emission, the two underfloor catalysts SCR and AMOx of Systems 2 and 3, respectively, were shown to be capable of removing the majority of ammonia emission measured at the inlet of the catalytic function positioned underfloor. The test numbers showed that the configurations of Systems 2 and 3 were able to reduce ammonia emission levels by 80 to 95%, respectively. The AMOx catalyst in System 3 was found to be even more effective than the SCR catalytic function in terms of removing ammonia. In System 3, ammonia has been almost completely removed from the exhaust stream when measured at the tailpipe of System 3.

### Example 2: Temperature Dependence and Ammonia Emission Level at Tailpipe

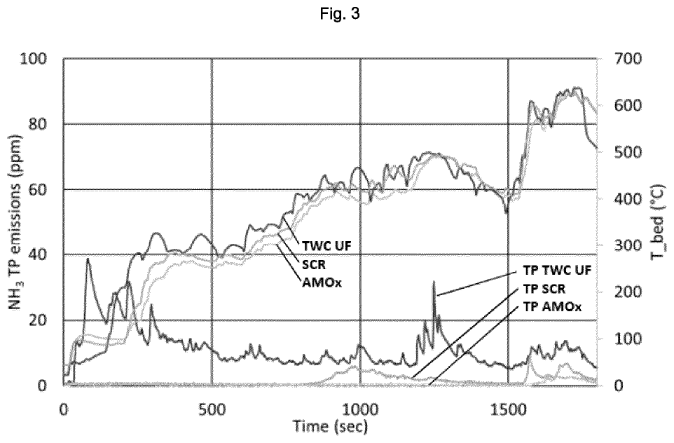

In Example 2, the temperature of the three catalyst functions positioned underfloor was studied for all three Systems 1 to 3 in dependence of time. The results are shown in FIG. 3. It was found that in all three configurations the maximum temperature at the underfloor position was not higher than about 600° C. Additionally, ammonia emissions at the tailpipe have been determined in all three configurations as shown in FIG. 3. System 2 and 3 were highly effective in purging ammonia from the exhaust gas stream, while the System 1 with the second three-way conversion catalyst (TWC) positioned underfloor was at least able of partially removing ammonia emissions. Therefore, it can be concluded that the SCR catalytic function in System 2 and the AMOx catalytic function in System 3 were able to prevent any substantial release or leakage of ammonia stored and converted in a time- or temperature-dependent manner in the respective SCR or AMOX catalyst positioned underfloor. No surging release of ammonia stored by the SCR (System 2) or AMOx catalytic function (System 3) could be observed at high temperatures.

### Example 3: Effect of NOx Emission at Tailpipe Under WLTC Heavy Drive Load

In Example 3, the performance of the three different configurations were studied under worldwide-harmonized light duty test procedure (WLTC, heavy drive load) as explained above with respect to nitrogen oxide (NOx) tailpipe emissions.

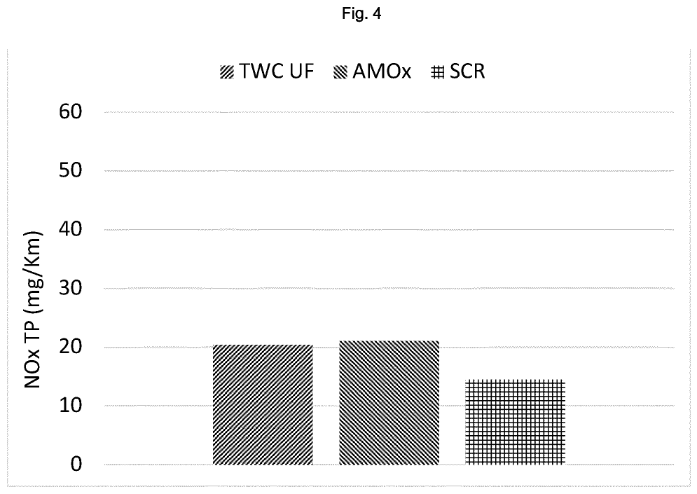

The data shown in FIG. 4 illustrates that the additional AMOx catalyst function of System 3 allows significantly reducing ammonia emission while the level of NOx tailpipe is still comparable to the level of NOx emission found in the configuration of System 1, in which a second three-way conversion catalyst (TWC) has been used underfloor.

1. An exhaust gas treatment system for reducing ammonia emission from a gasoline engine comprising a three-way conversion catalyst (TWC) or a four-way conversion catalyst (FWC) with a particulate filter characterized in that the exhaust gas treatment system comprises an ammonia abatement catalyst comprising a selective catalytic reduction catalyst (SCR) and/or an ammonia oxidation catalyst (AMOx).

2. The exhaust gas treatment system according to claim 1, wherein the three-way conversion catalyst (TWC) or the four-way conversion catalyst (FWC) comprises a substrate and at least one catalytic washcoat present on said substrate, the catalytic washcoat comprising at least one precious metal or platinum group metal (PGM), an oxygen storage compound and a refractory metal oxide.

3. The exhaust gas treatment system according to claim 1, wherein the three-way conversion catalyst or four-way conversion catalyst is in close-coupled (CC) position.

4. The exhaust gas treatment system according to claim 1, wherein the three-way conversion catalyst (TWC) is coated on the particulate filter to form the four-way conversion catalyst (FWC).

5. The exhaust gas treatment system according to claim 1, wherein the particulate filter is not coated by the three-way conversion catalyst (TWC) and positioned downstream of the three-way conversion catalyst (TWC).

6. The exhaust gas treatment system according to claim 1, wherein the ammonia abatement catalyst is positioned downstream of the three-way conversion catalyst (TWC) or the four-way conversion catalyst (FWC).

7. The exhaust gas treatment system according to claim 1, wherein the ammonia abatement catalyst is in underfloor (UF) position.

8. The exhaust gas treatment system according to claim 1, wherein the particulate filter is positioned downstream of the three-way conversion catalyst (TWC) and upstream of the ammonia abatement catalyst comprising the selective catalytic reduction catalyst (SCR) and/or ammonia oxidation catalyst (AMOx).

9. The exhaust gas treatment system according to claim 1, wherein the ammonia abatement catalyst comprising the selective catalytic reduction catalyst (SCR) and/or the ammonia oxidation catalyst (AMOx) is configured as a stand-alone catalyst.

10. The exhaust gas treatment system according to claim 2, wherein the substrate is a wall flow filter substrate.

11. The exhaust gas treatment system according to claim 1, wherein the selective catalytic reduction catalyst (SCR) lacks any precious metal or platinum group metal.

12. The exhaust gas treatment system according to claim 1, wherein the selective catalytic reduction catalyst (SCR) comprises a metal-promoted molecular sieve, preferably an iron promoted or copper promoted zeolite.

13. The exhaust gas treatment system according to claim 1, wherein the ammonia oxidation catalyst (AMOx) comprises a precious metal or platinum group metal at a total loading of precious metal or platinum group metal from about 0.1 g/ft³ to about 10 g/ft³, calculated as the total weight of precious metal or platinum group metal of the volume of the AMOx catalyst.

14. The exhaust gas treatment system according to claim 1, wherein the ammonia oxidation catalyst (AMOx) comprises total precious metal or platinum group metal loading from about 0.01 wt. % to about 2 wt. %, based on the weight of the dry AMOx catalyst component.

15. A method of treating an exhaust gas stream from a gasoline engine comprising the steps of providing an exhaust gas stream from a gasoline engine comprising ammonia, and contacting the exhaust gas stream comprising ammonia with the exhaust gas treatment system according to claim 1 to reduce the ammonia emission in the exhaust gas stream.

16. The exhaust gas treatment system according to claim 1, wherein the selective catalytic reduction catalyst (SCR) comprises an iron-promoted or copper-promoted zeolite.
